(19) United States
(12) Patent Application Publication
(10) Pub. No.: US 2024/0411215 A1
(43) Pub. Date: Dec. 12, 2024

(54) WAVELENGTH CONVERSION MODULE AND PROJECTION APPARATUS

(71) Applicant: Coretronic Corporation, Hsin-Chu (TW)

(72) Inventor: I-Hua Chen, Hsin-Chu (TW)

(73) Assignee: Coretronic Corporation, Hsin-Chu (TW)

(21) Appl. No.: 18/736,503

(22) Filed: Jun. 6, 2024

(30) Foreign Application Priority Data
Jun. 12, 2023 (CN) 202310688049.X

(51) Int. Cl. G03B 21/20

(52) U.S. Cl. CPC G03B 21/204; G03B 21/2066

(57) ABSTRACT

A wavelength conversion module including a substrate, a wavelength conversion layer and a diffuse reflection layer is provided. The wavelength conversion layer is disposed on the substrate, and the diffuse reflection layer is disposed between the substrate and the wavelength conversion layer. The diffuse reflection layer includes a plurality of first diffuse reflection particles and a plurality of second diffuse reflection particles, wherein a volume of each second diffuse reflection particle is 0.3% to 7% of an average volume of the first diffuse reflection particles, and a whiteness of the second diffuse reflection particles is greater than or equal to a whiteness of the first diffuse reflection particles. A projection apparatus is also provided.

### CROSS-REFERENCE TO RELATED APPLICATION

This application claims the priority benefit of China application serial no. 202310688049.X, filed on Jun. 12, 2023. The entirety of the above-mentioned patent application is hereby incorporated by reference herein and made a part of this specification.

### BACKGROUND

### Technical Field

The disclosure relates to an optical module and a display device, and particularly relates to a wavelength conversion module and a projection apparatus.

### Description of Related Art

An existing phosphor wheel used in a projection apparatus includes a substrate, a diffuse reflection layer and a phosphor layer, where the diffuse reflection layer is formed on the substrate, and the phosphor layer is formed on the diffuse reflection layer. After the phosphor layer is excited by excitation light, it emits fluorescent light with a corresponding wavelength, and the diffuse reflection layer is used to reflect the fluorescent light, and a material of commonly used diffuse reflection particles is white particles of alumina, silicon dioxide or titanium dioxide, etc.

Since the existing diffuse reflection particles are all selected to have a particle size (such as 400 to 700 nm) close to a wavelength of visible light, regardless of whether a single type diffuse reflection particles or multiple types of diffuse reflection particles are used, similar particle sizes of diffuse reflection particles are used, so that during curing or sintering, it is easy to cause cracks in the diffuse reflection layer due to shrinkage, which in turn affects the reliability and reflection uniformity of the diffuse reflection layer.

In addition, the diffuse reflection particles of the diffuse reflection layer often use materials with whiteness greater than 80 and having high refractive index, such as alumina, silicon dioxide, titanium dioxide, tin dioxide, zinc oxide, zirconium oxide and other materials. When the excitation light excites the phosphor layer, light energy and heat energy may be generated, and the light energy is reflected to a light receiving system through the diffuse reflection layer, while the heat energy is dissipated through surface or the heat energy is conducted to the substrate through the diffuse reflection layer for heat dissipation, so that the diffuse reflection particles require a higher thermal conductivity, wherein aluminum oxide and zinc oxide have higher thermal conductivity and have good thermal conduction effect. However, in comparison, zinc oxide is prone to aging under high temperature and high humidity conditions, while aluminum oxide has the characteristics of high hardness, high stability, high heat resistance, low expansion coefficient, high corrosion resistance, etc., so that aluminum oxide is widely used as a diffuse reflection material in the industry.

However, the greater a refractive index difference between the diffuse reflection particles and air is, the higher the reflectivity is, and the refractive index of aluminum oxide is about 1.76, compared with titanium dioxide, tin dioxide, zinc oxide, zirconium oxide and other oxides with the refractive index greater than 2, the refractive index of aluminum oxide is lower, so that the use of aluminum oxide as the diffuse reflection material has a disadvantage of low reflectivity.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

An embodiment of the disclosure provides a wavelength conversion module including a substrate, a wavelength conversion layer and a diffuse reflection layer. The wavelength conversion layer is disposed on the substrate, and the diffuse reflection layer is disposed between the substrate and the wavelength conversion layer. The diffuse reflection layer includes a plurality of first diffuse reflection particles and a plurality of second diffuse reflection particles, wherein a volume of each second diffuse reflection particle is 0.3% to 7% of an average volume of the first diffuse reflection particles, and a whiteness of the second diffuse reflection particles is greater than or equal to a whiteness of the first diffuse reflection particles.

An embodiment of the disclosure provides a projection apparatus including an illumination module, a light valve and a projection lens. The illumination module is configured to provide an illumination beam, which includes a light source and the aforementioned wavelength conversion module, wherein the light source is configured to emit a laser beam, and the wavelength conversion module is disposed on a transmission path of the laser beam. The wavelength conversion layer is configured to convert the laser beam into a wavelength converted beam, and the diffuse reflection layer is configured to diffusely reflect the wavelength converted beam. The illumination beam includes at least one of the wavelength converted beam and the laser beam. The light valve is disposed on a transmission path of the illumination beam, and is configured to convert the illumination beam into an image beam. The projection lens is disposed on a transmission path of the image beam.

Other objectives, features and advantages of the present disclosure will be further understood from the further technological features disclosed by the embodiments of the present disclosure wherein there are shown and described preferred embodiments of this disclosure, simply by way of illustration of modes best suited to carry out the disclosure.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a schematic front view of a wavelength conversion module according to an embodiment of the disclosure.

FIG. 2 is a schematic cross-sectional view of the wavelength conversion module of FIG. 1 along a line I-I.

FIG. 3A and FIG. 3B illustrate a configuration relationship of first diffuse reflection particles and a second diffuse reflection particle in two embodiments of the disclosure.

FIG. 4 is a schematic diagram of a projection apparatus according to an embodiment of the disclosure.

FIG. 5 is a schematic diagram of an optical path of the projection apparatus according to an embodiment of FIG. 4.

### DESCRIPTION OF THE EMBODIMENTS

In the following detailed description of the preferred embodiments, reference is made to the accompanying drawings which form a part hereof, and in which are shown by way of illustration specific embodiments in which the disclosure may be practiced. In this regard, directional terminology, such as “top,” “bottom,” “front,” “back,” etc., is used with reference to the orientation of the Figure(s) being described. The components of the present disclosure can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

The disclosure is directed to a wavelength conversion module, which has good light efficiency, good heat dissipation effect and good reliability. Also, the disclosure is directed to a projection apparatus, which has good light efficiency, good heat dissipation effect and good reliability. Additional aspects and advantages of the present disclosure will be set forth in the description of the techniques disclosed in the present disclosure.

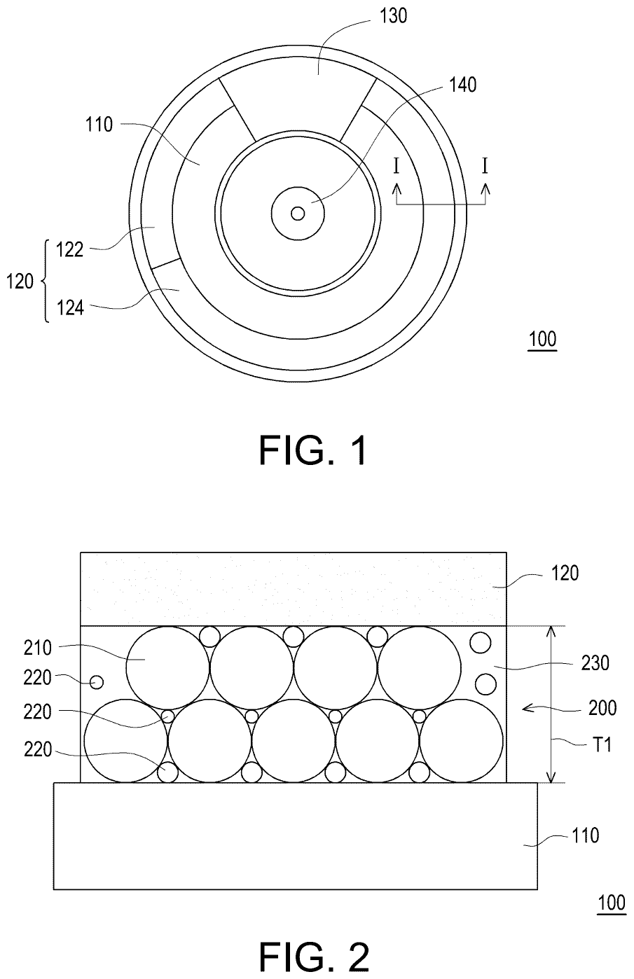

FIG. 1 is a schematic front view of a wavelength conversion module according to an embodiment of the disclosure, and FIG. 2 is a schematic cross-sectional view of the wavelength conversion module of FIG. 1 along a line I-I. Referring to FIG. 1 and FIG. 2, a wavelength conversion module 100 of the embodiment includes a substrate 110, a wavelength conversion layer 120 and a diffuse reflection layer 200. The wavelength conversion layer 120 is disposed on the substrate 110, and the diffuse reflection layer 200 is disposed between the substrate 110 and the wavelength conversion layer 120. In the embodiment, the wavelength conversion layer 120 is a phosphor layer, and the wavelength conversion layer 120 is, for example, C-shaped or O-shaped and disposed around a central axis of the substrate 110. For example, as shown in FIG. 1, the wavelength conversion layer 120 may include a green phosphor layer 122 and a yellow phosphor layer 124. However, in other embodiments, the wavelength conversion layer 120 may also include a red phosphor layer or a combination of phosphor layers of other colors.

The diffuse reflection layer 200 includes a plurality of first diffuse reflection particles 210 and a plurality of second diffuse reflection particles 220, wherein a volume of each second diffuse reflection particle 220 is 0.3% to 7% of an average volume of the first diffuse reflection particles 210. Namely, a size of each second diffuse reflection particle 220 is smaller than a size of each first diffuse reflection particle 210. In addition, a whiteness of the second diffuse reflection particles 220 is greater than or equal to a whiteness of the first diffuse reflection particles 210.

In the wavelength conversion module 100 of the embodiment, two types of diffuse reflection particles (i.e. the first diffuse reflection particles 210 and the second diffuse reflection particles 220) with different sizes are used, wherein the volume of each second diffuse reflection particle 220 is 0.3% to 7% of the average volume of the first diffuse reflection particles 210, and the whiteness of the second diffuse reflection particles 220 is greater than or equal to the whiteness of the first diffuse reflection particles 210. Therefore, these second diffuse reflection particles 220 may be filled in gaps generated by these first diffuse reflection particles 210, which may additionally increase an amount of diffusely reflected light, thereby effectively improving the reflectivity of the diffuse reflection layer 200, and thus increases a contact area between the diffuse reflection particles (such as the first diffuse reflection particles 210 and the second diffuse reflection particles 220) and the substrate 110, thereby increasing a heat dissipation effect and reliability of the diffuse reflection layer 200. Therefore, the wavelength conversion module 100 using the diffuse reflection layer 200 of the embodiment may have good light efficiency, good heat dissipation effect and good reliability. In the embodiment, after the second diffuse reflection particles 220 are used to fill the gaps generated by the first diffuse reflection particles 210, compared with the situation that only the first diffuse reflection particles 210 are used, a contact surface area between the diffuse reflection particles and the substrate 110 is increased by 3% to 13%.

In the embodiment, since the second diffuse reflection particles 220 are used to fill the gaps generated by the first diffuse reflection particles 210, a total volume of the diffuse reflection particles increases compared to the situation that only the first diffuse reflection particles 210 are used, so that the reflectivity of the diffuse reflection layer 200 (for example, reflectivity of visible light) is increased by 1 to 2%. In addition, in the embodiment, since by using the second diffuse reflection particles 220 to fill the gaps generated by the first diffuse reflection particles 210, it may provide a support effect. Therefore, when the diffuse reflection layer 200 is cured or sintered, a shrinkage phenomenon may be suppressed, and the probability of edge warping, falling off or cracks occurred in the diffuse reflection layer 200 during the curing or sintering process may be reduced, so as to maintain uniformity and flatness of the diffuse reflection layer 200, thereby improving the reflection uniformity of the diffuse reflection layer 200 and increasing the reliability of the diffuse reflection layer 200.

In the embodiment, a diameter of each second diffuse reflection particle 220 is 15% to 42% of an average diameter of the first diffuse reflection particles 210. In an embodiment, the first diffuse reflection particles 210 and the second diffuse reflection particles 220 may be spherical. In addition, in the embodiment, the diffuse reflection layer 200 further includes a colloid 230, the colloid 230 at least partially wraps the first diffuse reflection particles 210 and the second diffuse reflection particles 220, and fills gaps generated by the first diffuse reflection particles 210 and/or the second diffuse reflection particles 220. In an embodiment, a volume of the colloid 230 accounts for 25 to 45 vol % of the total volume of the diffuse reflection layer 200, wherein “vol %” is a volume percentage. In addition, in an embodiment, a total volume of these first diffuse reflection particles 210 accounts for 50 to 60 vol % of the total volume of the diffuse reflection layer 230, and a total volume of these second diffuse reflection particles 220 accounts for 5 to 15 vol % of the total volume of the diffuse reflection layer 230.

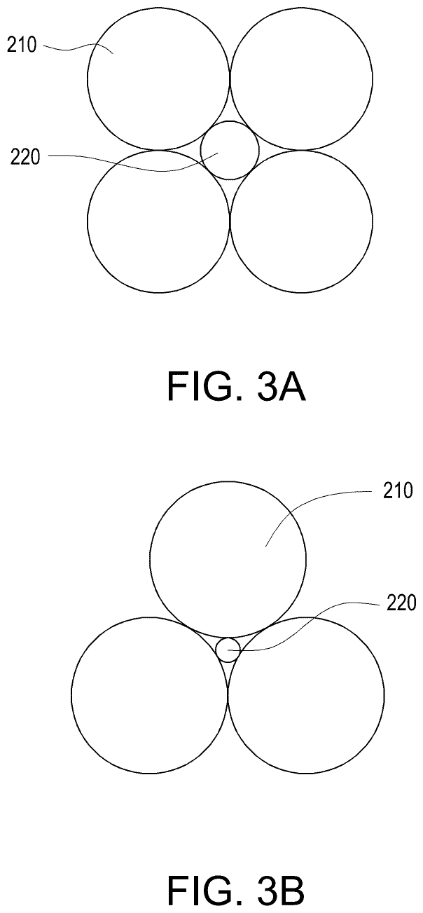

In the embodiment, the second diffuse reflective particles 220 and the first diffuse reflective particles 210 are mixed in the diffuse reflective layer 200, for example, uniformly mixed in the diffuse reflective layer 200. In the embodiment, the second diffuse reflection particles 220 are located in the gaps among the first diffuse reflection particles 210. Specifically, at least a part of the second diffuse reflection particles 220 is located in the gaps between two or more first diffuse reflection particles 210 that are in contact with each other. As shown in FIG. 3A, in an embodiment, the second diffuse reflection particle 220 is located in the gap among the four first diffuse reflection particles 210 that are in contact with each other. As shown in FIG. 3B, in an embodiment, the second diffuse reflection particle 220 is located in the gap among the three first diffuse reflection particles 210 that are in contact with each other. In addition, FIG. 2 schematically shows that the first diffuse reflective particles 210 are filled and stacked in two layers, but the disclosure is not limited thereto, in fact, the first diffuse reflective particles 210 may also be filled and stacked in more than two layers or only one layer.

In the embodiment, a ratio of a refractive index of the second diffuse reflection particles 220 to a refractive index of the first diffuse reflection particles 210 is greater than 1.1. Therefore, when the gaps generated by the first diffuse reflection particles 210 are filled with the second diffuse reflection particles 220, an average refractive index of the diffuse reflection layer 200 may be increased, thereby increasing the reflectivity of the diffuse reflection layer 200 by 1 to 2% compared with the situation that only the first diffuse reflection particles 210 are used.

A material of the first diffuse reflection particles 210 is, for example, aluminum oxide (Al₂O₃), but the disclosure is not limited thereto. In addition, a material of the second diffuse reflection particles 220 is, for example, one of titanium dioxide (TiO₂), tin dioxide (SnO₂), zinc oxide (ZnO), zirconium dioxide (ZrO₂) or a combination thereof, but the disclosure is not limited thereto. In the embodiment, the colloid 230 is one of organic glue, inorganic glue, glass, siloxane, sol-gel or a combination thereof, but the disclosure is not limited thereto.

In the embodiment, in the case that an overall thermal conductivity of the diffuse reflection layer 200 is not reduced, under the condition that the volume of each second diffuse reflection particle 220 is 0.3% to 7% of the average volume of the first diffuse reflection particles, the second diffuse reflection particles 220 are easy to fill the gaps among the first diffuse reflection particles 210, thereby increasing the total volume and total surface area of the diffuse reflection particles, making it easier for light beams entering the diffuse reflection layer 200 to irradiate to diffuse reflection particles to enhance reflectivity. If the volume of each of the second diffuse reflection particles 220 exceeds an upper limit of the above-mentioned range, they are not easy to fill the gaps, but even causes larger gaps, thereby reducing the thermal conductivity; on the other hand, if the volume of each of the second diffuse reflection particles 220 does not reach a lower limit of the above range, although they may fill the gaps, the excessively smaller size means that they are not easy to be irradiated by the light beam, and improvement of the reflection effect is limited.

It should be noted that the same type of diffuse reflection particles may also have a certain particle size distribution, and those with ordinary knowledge in the field may understand that the above-mentioned condition of 0.3% to 7% may be deduced by measuring an average volume of multiple particles, and the measurement method may include measurement by an electron microscope (such as a scanning electron microscope). The electron microscope may capture a surface or cross-section of a diffuse reflection particle to obtain a particle diameter thereof, and obtain a volume of the diffuse reflection particle through particle diameter computation. In addition, the condition that the total volume of the second diffuse reflection particles 220 accounts for 5 to 15 vol % of the total volume of the diffuse reflection layer 230 may also be measured through the electron microscope, or the colloid 230 may be removed, for example, after being removed by a solvent, the diffuse reflection particles of different particle sizes may be separated by means of centrifugation or sieving, and a total volume of the particles is measured. When a ratio of the total volume of the second diffuse reflection particles 220 exceeds an upper limit of the above range, these second diffuse reflection particles 220 have already filled all the gaps, and excessive second diffuse reflection particles 220 cannot further improve the reflectivity, which causes waste; on the other hand, if the ratio of the total volume of the second diffuse reflection particles 220 does not reach the lower limit of the above-mentioned range, there will be some gaps not filled with the second diffuse reflection particles 220, resulting in limited enhancement of the reflection effect.

In the embodiment, a thickness Tl of the diffuse reflection layer 200 falls within a range of 0.05 mm to 0.20 mm, where the thickness Tl is a height perpendicular to an extending direction of the substrate 110, for example, a perpendicular spacing distance between the substrate 110 and the wavelength conversion layer 120.

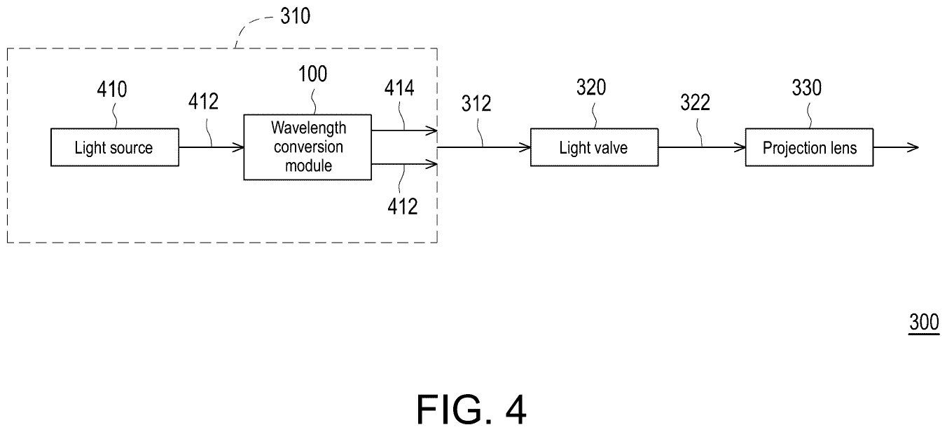

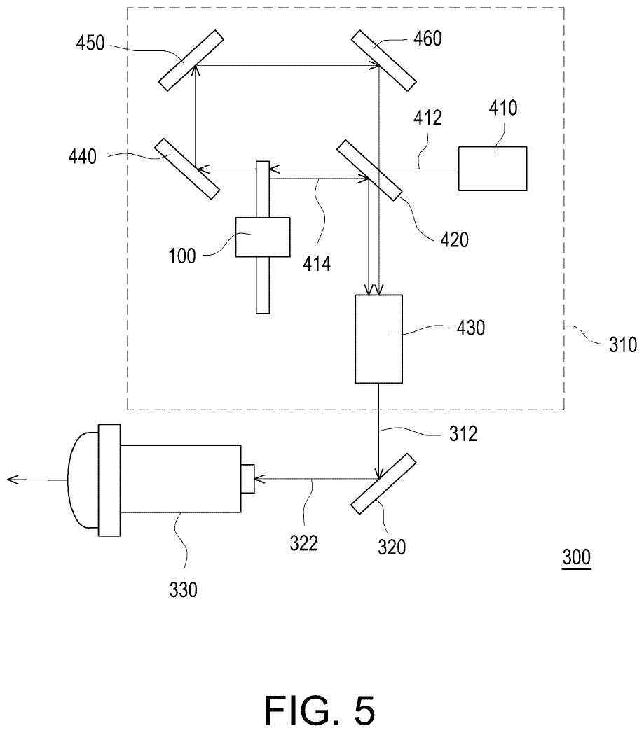

FIG. 4 is a schematic diagram of a projection apparatus according to an embodiment of the disclosure. FIG. 5 is a schematic diagram of an optical path of the projection apparatus according to an embodiment of FIG. 4. Referring to FIG. 1, FIG. 2, FIG. 4 and FIG. 5, the projection apparatus 300 of the embodiment includes an illumination module 310, a light valve 320 and a projection lens 330. The illumination module 310 is configured to provide an illumination beam 312. The illumination module 310 includes a light source 410 and the aforementioned wavelength conversion module 100. The light source 410 is configured to emit a laser beam 412. In the embodiment, the light source 410 is, for example, at least one laser emitter or at least one laser diode. For example, the light source 410 may be a blue laser diode, and the laser beam 412 is a blue laser beam. The wavelength conversion module 100 is disposed on a transmission path of the laser beam 412. The wavelength conversion layer 120 is used for being excited by the laser beam 412 to produce a wavelength converted beam 414, and the diffuse reflection layer 200 is configured to diffusely reflect the wavelength converted beam 414. The illumination beam 312 includes at least one of the wavelength converted beam 414 and the laser beam 412.

Specifically, after the laser beam 412 irradiates the wavelength conversion layer 120 (such as the green phosphor layer 122 and the yellow phosphor layer 124 in FIG. 1), the wavelength converted beam 414 is excited, wherein the wavelength converted beam 414 is, for example, one of green light, yellow light, and red light or a combination thereof. In the embodiment, the wavelength conversion module 100 further includes a light-transmitting region 130, and a light-transmitting glass or a light-through opening may be disposed in the light-transmitting region 130. In addition, the wavelength conversion module 100 further includes a motor (not shown), and a rotating shaft 140 of the motor is connected to the substrate 110 to drive the substrate 110 to rotate. When the substrate 110 is driven by the rotating shaft 140 of the motor to rotate around the rotating shaft 140 serving as a central axis, the wavelength conversion layer 120 and the light-transmitting region 130 cut into the transmission path of the laser beam 412 in sequence. A dichroic mirror 420 may be disposed between the light source 410 and the wavelength conversion module 100, and the dichroic mirror 420 is suitable for allowing the laser beam 412 to pass through for being transmitted to the wavelength conversion module 100. When the wavelength conversion layer 120 cuts into the transmission path of the laser beam 412, the wavelength conversion layer 120 converts the laser beam 412 into the wavelength converted beam 414, and the dichroic mirror 420 is suitable for reflecting the wavelength converted beam to a light homogenizing element 430, where the light homogenizing element 430 is, for example, a light integrating rod or a lens array.

When the light-transmitting region 130 of the wavelength conversion module 100 cuts into the transmission path of the laser beam 412, the laser beam 412 penetrates through the light-transmitting region 130, and is then reflected back to the dichroic mirror 420 by a reflector 440, a reflector 450 and a reflector 460 in sequence, and then passes through the dichroic mirror 420 to reach the light homogenizing element 430. The light homogenizing element 430 homogenizes the laser beam 412 and the wavelength converted beam 414 to form the illumination beam 312. In another embodiment, the wavelength conversion module 100 may also be provided with a reflective region instead of the light-transmitting region 130, and the laser beam 412 reflected by the reflective region may still be transmitted to the light homogenizing element 430 through other reflectors or dichroic mirrors.

The light valve 320 is disposed on a transmission path of the illumination beam 312, and is configured to convert the illumination beam 312 into an image beam 322. In the embodiment, the light valve 320 is, for example, a digital micro-mirror device (DMD), a liquid-crystal-on-silicon panel (LCOS panel), a transmissive liquid crystal panel, or other spatial light modulators. The projection lens 330 is disposed on a transmission path of the image beam 322 to project the image beam 322 onto a screen or a projection surface to form an image. Since the wavelength conversion module 100 adopts the design of the above-mentioned diffuse reflection layer 200, the projection apparatus 300 of the embodiment may have good light efficiency, good image quality, good heat dissipation effect and good reliability.

In summary, the embodiments of the disclosure have at least one of following advantages and effects. In the wavelength conversion module and the projection apparatus of the embodiments of the disclosure, two types of diffuse reflection particles with different sizes are adopted, wherein the volume of each second diffuse reflection particle is 0.3% to 7% of the average volume of the first diffuse reflection particles, and the whiteness of the second diffuse reflection particles is greater than or equal to the whiteness of the first diffuse reflection particles. Therefore, the second diffuse reflection particles may be filled in the gaps generated by the first diffuse reflection particles, which additionally increases an amount of diffusely reflected light, thereby effectively improving the reflectivity of the diffuse reflection layer, and thus increases a contact area between the diffuse reflection particles and the substrate, thereby increasing a heat dissipation effect and reliability of the diffuse reflection layer. Therefore, the wavelength conversion module and the projection apparatus of the embodiment of the disclosure using the above-mentioned diffuse reflection layer may have good light efficiency, good heat dissipation effect and good reliability.

The foregoing description of the preferred embodiments of the disclosure has been presented for purposes of illustration and description. It is not intended to be exhaustive or to limit the disclosure to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the disclosure and its best mode practical application, thereby to enable persons skilled in the art to understand the disclosure for various embodiments and with various modifications as are suited to the particular use or implementation contemplated. It is intended that the scope of the disclosure be defined by the claims appended hereto and their equivalents in which all terms are meant in their broadest reasonable sense unless otherwise indicated. Therefore, the term “the disclosure”, “the present disclosure” or the like does not necessarily limit the claim scope to a specific embodiment, and the reference to particularly preferred exemplary embodiments of the disclosure does not imply a limitation on the disclosure, and no such limitation is to be inferred. The disclosure is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the disclosure. It should be appreciated that variations may be made in the embodiments described by persons skilled in the art without departing from the scope of the present disclosure as defined by the following claims. Moreover, no element and component in the present disclosure is intended to be dedicated to the public regardless of whether the element or component is explicitly recited in the following claims.

What is claimed is:

1. A wavelength conversion module, comprising:
a substrate;
a wavelength conversion layer, disposed on the substrate; and
a diffuse reflection layer, disposed between the substrate and the wavelength conversion layer, the diffuse reflection layer comprising a plurality of first diffuse reflection particles and a plurality of second diffuse reflection particles, wherein a volume of each of the second diffuse reflection particles is 0.3% to 7% of an average volume of the first diffuse reflection particles, and a whiteness of the second diffuse reflection particles is greater than or equal to a whiteness of the first diffuse reflection particles.

2. The wavelength conversion module as claimed in claim 1, wherein a total volume of the first diffuse reflection particles accounts for 50 to 60 vol % of a total volume of the diffuse reflection layer, and a total volume of the second diffuse reflection particles accounts for 5 to 15 vol % of the total volume of the diffuse reflection layer.

3. The wavelength conversion module as claimed in claim 1, wherein a ratio of a refractive index of the second diffuse reflection particles to a refractive index of the first diffuse reflection particles is greater than 1.1.

4. The wavelength conversion module as claimed in claim 1, wherein a material of the first diffuse reflection particles is aluminum oxide.

5. The wavelength conversion module as claimed in claim 1, wherein a material of the second diffuse reflection particles is one of titanium dioxide, tin dioxide, zinc oxide, zirconium dioxide or a combination thereof.

6. The wavelength conversion module as claimed in claim 1, wherein the diffuse reflection layer further comprises a colloid, and a volume of the colloid accounts for 25 to 45 vol % of a total volume of the diffuse reflection layer.

7. The wavelength conversion module as claimed in claim 6, wherein the colloid is one of organic glue, inorganic glue, glass, siloxane, sol-gel or a combination thereof.

8. The wavelength conversion module as claimed in claim 1, wherein a thickness of the diffuse reflection layer falls within a range of 0.05 mm to 0.20 mm.

9. The wavelength conversion module as claimed in claim 1, wherein the second diffuse reflection particles are mixed with the first diffuse reflection particles in the diffuse reflection layer.

10. The wavelength conversion module as claimed in claim 1, wherein the second diffuse reflection particles are located in gaps among the first diffuse reflection particles.

11. The wavelength conversion module as claimed in claim 1, wherein at least a part of the second diffuse reflection particles are located in a gap between two of the first diffuse reflection particles contacting with each other.

12. The wavelength conversion module as claimed in claim 1, wherein a diameter of each second diffuse reflection particle is 15% to 42% of an average diameter of the first diffuse reflection particles.

13. A projection apparatus, comprising:
an illumination module, configured to provide an illumination beam, and comprising a light source and a wavelength conversion module, wherein the light source is configured to emit a laser beam, and the wavelength conversion module is disposed on a transmission path of the laser beam, and comprises:
a substrate;
a wavelength conversion layer, disposed on the substrate, and configured to convert the laser beam into a wavelength converted beam; and
a diffuse reflection layer, disposed between the substrate and the wavelength conversion layer, and configured to diffusely reflect the wavelength converted beam, the diffuse reflection layer comprising a plurality of first diffuse reflection particles and a plurality of second diffuse reflection particles, wherein a volume of each of the second diffuse reflection particles is 0.3% to 7% of an average volume of the first diffuse reflection particles, and a whiteness of the second diffuse reflection particles is greater than or equal to a whiteness of the first diffuse reflection particles, wherein the illumination beam comprises at least one of the wavelength converted beam and the laser beam;
a light valve, disposed on a transmission path of the illumination beam, and configured to convert the illumination beam into an image beam; and
a projection lens, disposed on a transmission path of the image beam.

14. The projection apparatus as claimed in claim 13, wherein a total volume of the first diffuse reflection particles accounts for 50 to 60 vol % of a total volume of the diffuse reflection layer, and a total volume of the second diffuse reflection particles accounts for 5 to 15 vol % of the total volume of the diffuse reflection layer.

15. The projection apparatus as claimed in claim 13, wherein a ratio of a refractive index of the second diffuse reflection particles to a refractive index of the first diffuse reflection particles is greater than 1.1.

16. The projection apparatus as claimed in claim 13, wherein a material of the first diffuse reflection particles is aluminum oxide.

17. The projection apparatus as claimed in claim 13, wherein a material of the second diffuse reflection particles is one of titanium dioxide, tin dioxide, zinc oxide, zirconium dioxide or a combination thereof.

18. The projection apparatus as claimed in claim 13, wherein the diffuse reflection layer further comprises a colloid, and a volume of the colloid accounts for 25 to 45 vol % of a total volume of the diffuse reflection layer.

19. The projection apparatus as claimed in claim 18, wherein the colloid is one of organic glue, inorganic glue, glass, siloxane, sol-gel or a combination thereof.

20. The projection apparatus as claimed in claim 13, wherein a thickness of the diffuse reflection layer falls within a range of 0.05 mm to 0.20 mm.

21. The projection apparatus as claimed in claim 13, wherein the second diffuse reflection particles are mixed with the first diffuse reflection particles in the diffuse reflection layer.

22. The projection apparatus as claimed in claim 13, wherein the second diffuse reflection particles are located in gaps among the first diffuse reflection particles.

23. The projection apparatus as claimed in claim 13, wherein at least a part of the second diffuse reflection particles are located in a gap between two of the first diffuse reflection particles contacting with each other.

24. The projection apparatus as claimed in claim 13, wherein a diameter of each second diffuse reflection particle is 15% to 42% of an average diameter of the first diffuse reflection particles.
